(19) United States
(12) Patent Application Publication
(10) Pub. No.: US 2015/0131715 A1
(43) Pub. Date: May 14, 2015

(54) IMAGE TRANSMISSION APPARATUS, IMAGE TRANSMISSION METHOD, AND RECORDING MEDIUM

(71) Applicant: CANON KABUSHIKI KAISHA, Tokyo (JP)

(72) Inventor: Takeshi Ozawa, Kawasaki-shi (JP)

(21) Appl. No.: 14/536,495

(22) Filed: Nov. 7, 2014

(30) Foreign Application Priority Data
Nov. 11, 2013 (JP) 2013-233494

(51) Int. Cl. H04N 19/115; H04N 19/176; H04N 19/164; H04N 19/89

(52) U.S. Cl. CPC H04N 19/115; H04N 19/89; H04N 19/176; H04N 19/164
USPC 375/240.02

(57) ABSTRACT

Convention transmission of streams of moving images disadvantageously has a long stopping time because frame transmission skip and GOP transmission skip are performed in a case where a congestion of a transmission process occurs in a transmission side. An image transmission apparatus which transmits encoded data acquired by encoding an image according to the present invention includes a first acquiring unit configured to acquire information on a congestion of transmission of the encoded data, a second acquiring unit configured to acquire a priority level of a target tile that is one of tiles acquired by dividing the image, and a determination unit configured to determine encoded data corresponding to the target tile to be output externally from the image transmission apparatus based on the information on the congestion of transmission acquired by the first acquiring unit and the priority level of the target tile acquired by the second acquiring unit.

### BACKGROUND OF THE INVENTION

1. Field of the Invention

The present invention relates to an image transmission apparatus, an image transmission method, and a recording medium for transmitting image data divided into tiles over a network.

2. Description of the Related Art

In recent years, a technology has been known which transmits a stream of moving image data to a network such as the Internet in real time. Such a technology may be applied to a TV conference system or a surveillance camera (monitoring camera) system, for example.

A stream of moving image data to be transmitted is first compressing-encoded (hereinafter, simply called “encoded”) before the transmission. H.264/MPEG-4 AVC (hereinafter, called H.264) has been known as a typical moving image encoding scheme. Moving image encoding schemes including H.264 may encode by using what-is-called inter-frame prediction. Encoded data generated by encoding moving images by applying inter-frame prediction contains a what-is-called key frame containing one frame data which may be decoded with the frame data only and a frame containing frame data which may be decoded with reference to another frame data. Here, a group of frames from a key frame to a frame one before the next key frame will be collectively called a GOP (Group of Pictures).

In recent years, according to JCT-VC (Joint Collaborative Team on Video Coding), HEVC (High Efficiency Video Coding) has been standardized as a successor to H.264. HEVC allows encoding by using inter-frame prediction, like H.264. HEVC applies a tile method in which one frame of a moving image to be encoded is spatially divided into a grid-like area to allow parallel processes such as encoding and decoding processes, which is one different element from H.264. Application of the tile method may allow performing encoding and decoding in parallel for faster processing. Encoding in tiles may further incorporate a what-is-called ROI (Region Of Interest) function into a moving image encoding scheme. A tile technology is also applied in JPEG2000 encoding scheme, but JPEG2000 encoding scheme does not disclose a method for decoding only a part of tiles and handling it as an ROI.

On the other hand, conventionally, real time moving image stream transmissions apply a streaming transmission protocol called RTSP/RTP (Real Time Streaming Protocol/Real-time Transport Protocol). stream transmissions of moving images based on RTSP/RTP may need inhibiting increases in a congestion of a network, encoding processing loads caused by a transmitting device and decoding processing loads caused by a receiving device and prevention of a delay from image capturing with a camera to reproduction by a receiving device.

Encoding an image (moving image) having more pixels than before by using an encoding scheme such as HEVC and transmitting a stream of the encoded moving image data in real time by applying RTSP/RTP may result in a larger load of the decoding processing of the moving image than before. In other words, a higher load of the decoding processing may possibly prevent the decoding processing and reception of streams from catching up the transmission rate of the encoded data. A higher load of the decoding processing may result in a congestion of stream transmissions.

Examples in which a congestion of a stream transmission occurs will be described. A congestion of a stream transmission may occur easily in communication based on TCP (Transmission Control Protocol) rather than UDP (User Datagram Protocol) as a communication protocol (communication scheme). RTSP/RTP over TCP may be an example of stream transmission protocols based on TCP. In a stream transmission based on TCP, when packet reception by a receiver delays, a response with an ACK packet acknowledging that the reception has succeeded may delay. Because the transmission side keeps waiting for the reception of the ACK packet, the next packet transmission may delay. Thus, when accumulation of delays of packet transmission in the transmission side result in full of a transmission packet buffer of the transmitting device (or a buffer having an available storage capacity equal to or lower than a predetermined capacity), another packet transmission may not temporarily be processed (transmission failure). Such a failure in packet transmission in the transmission side may cause a congestion of a stream transmission.

Conventionally, when a packet transmission fails in a transmission side, a process for skipping transmission of frame data of a target to be transmitted including a packet as described above (hereinafter, called frame transmission skip) to prevent a congestion of a stream transmission process.

According to the conventional method, when the frame transmission skip is performed, a part of skipped frame data is not transmitted from a transmission side. Thus, a receiving device having received the rest of the frame data may not reproduce the frame data, causing a break in the moving image. In a case where the frame data to be skipped are data encoded with intra-frame prediction, a transmitting device may perform a process for skipping data transmission in GOPs including the frame data to be skipped (hereinafter, called GOP transmission skip). Performing such GOP transmission skip may stop transmission of the moving image during a period from the GOP transmission skip to generation of the next GOP. The time period of the resulting break in the moving image may be longer than that in a case where the frame transmission skip is performed.

Thus, in conventional real time stream transmissions of a moving image, use of frame transmission skip or GOP transmission skip to prevent a congestion of a stream transmission process in a transmission side may possibly increase the period where the moving image stops.

### SUMMARY OF THE INVENTION

In order to solve the problems, an image transmission apparatus according to the present invention may be configured as follows. That is, an image transmission apparatus which transmits encoded data acquired by encoding an image according to the present invention includes a first acquiring unit configured to acquire information on a congestion of transmission of the encoded data, a second acquiring unit configured to acquire a priority level of a target tile that is one of tiles acquired by dividing the image, and a determination unit configured to determine encoded data corresponding to the target tile to be output externally from the image transmission apparatus based on the information on the congestion of transmission acquired by the first acquiring unit and the priority level of the target tile acquired by the second acquiring unit.

Further features of the present invention will become apparent from the following description of exemplary embodiments with reference to the attached drawings.

The present invention may allow a transmitting device to skip data transmission in tiles. In other words, tiles excluding a tile to be skipped within a frame containing the tile to be skipped may be transmitted. Therefore, a moving image of tile parts having higher priority levels may be transmitted as successive frames. This may prevent a break of the moving image reproduced by a reception side.

### BRIEF DESCRIPTION OF THE DRAWINGS

FIG. 1 is a diagram illustrating a connection state between a transmitting device and receiving devices according to exemplary embodiments of the present invention.

FIG. 2 is a block diagram illustrating a configuration of a network camera (image transmission apparatus) according to a first exemplary embodiment.

FIGS. 3A to 3E illustrate tile divisions of a moving image frame and priority levels of tiles.

FIG. 4 is a flowchart illustrating a tile data transmission process based on an available storage capacity of a transmission buffer and priority levels set for tiles according to the first exemplary embodiment.

FIG. 5 is a detail flowchart illustrating selective tile transmission process according to the first exemplary embodiment.

FIG. 6 is a detail flowchart illustrating a selective tile transmission process according to a second exemplary embodiment.

FIG. 7 is a detail flowchart illustrating a selective tile transmission process according to a third exemplary embodiment.

FIG. 8 is a detail flowchart illustrating a selective tile transmission process according to a fourth exemplary embodiment.

FIGS. 9A and 9B are detail flowcharts illustrating another example of the selective tile transmission process according to the fourth exemplary embodiment.

FIG. 10 is a flowchart illustrating a tile data transmission process based on an available storage capacity of a transmission buffer and priority levels set for tiles according to the fourth exemplary embodiment.

FIG. 11 is a hardware configuration example of a computer to which an image transmission apparatus according to the present invention is applicable.

### DESCRIPTION OF THE EMBODIMENTS

Exemplary embodiments of the present invention will be described in detail with reference to examples thereof and attached drawings. It should be noted that configurations according to the following exemplary embodiments are given for illustration purpose only, and the present invention is no limited to the illustrated configurations.

According to exemplary embodiments below, a network camera including an encoding unit configured to encode moving image data by applying HEVC which allows processing in tiles distributes a stream of a moving image in real time to a plurality of clients which may reproduce it. It should be noted that the encoding unit included in the network camera according to exemplary embodiments below encodes moving image data (image) in encoding blocks. The term “tile” refers to an area including one or more encode blocks, and the expression “allows processing in tiles” refers to allowing parallel processes to be performed in areas corresponding to tiles. In the following exemplary embodiments, TCP is applied as a communication protocol.

Because network connections between a network camera and clients, exchanges of distribution media information, and starting and ending processes for stream transmission are similar to those in conventional methods, the description will be omitted.

### First Exemplary Embodiment

According to a first exemplary embodiment, RTSP/RTP over TCP which transmits a stream of moving images based on TCP is applied as a stream transmission protocol. Processes to be performed by a transmitting device will be described in a case where a higher load of decoding processing on multi-pixel moving image data in a receiving device delays packet reception and an ACK packet reply based on TCP and an available storage capacity of a transmission buffer within a transmitting device is equal to or lower than a predetermined capacity.

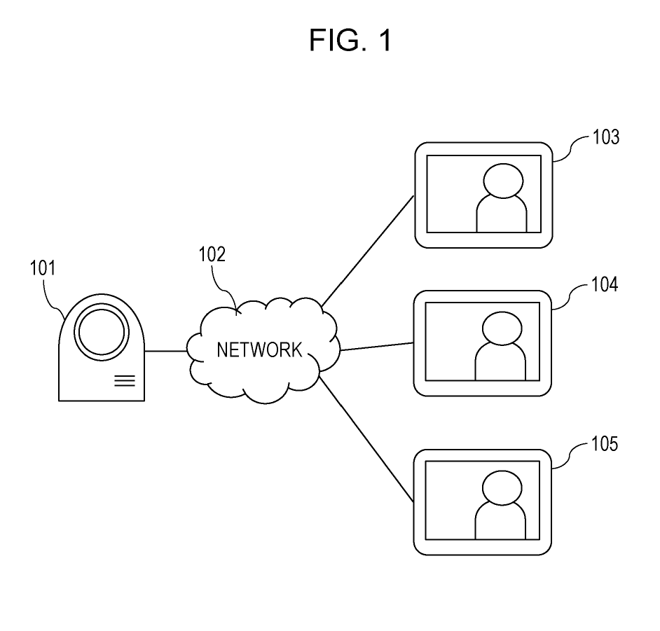

Processing in an entire system of this exemplary embodiment will be described with reference to FIG. 1. FIG. 1 illustrates an example of a connection configuration between a network camera (transmitting device) 101 and clients (receiving devices) 103 to 105 according to this exemplary embodiment. In this exemplary embodiment, the network camera 101 being a transmitting device is connected to the clients 103 to 105 being receiving devices over a network 102. It should be understood that the number of clients is not limited to three while three clients are illustrated in FIG. 1 of this exemplary embodiment.

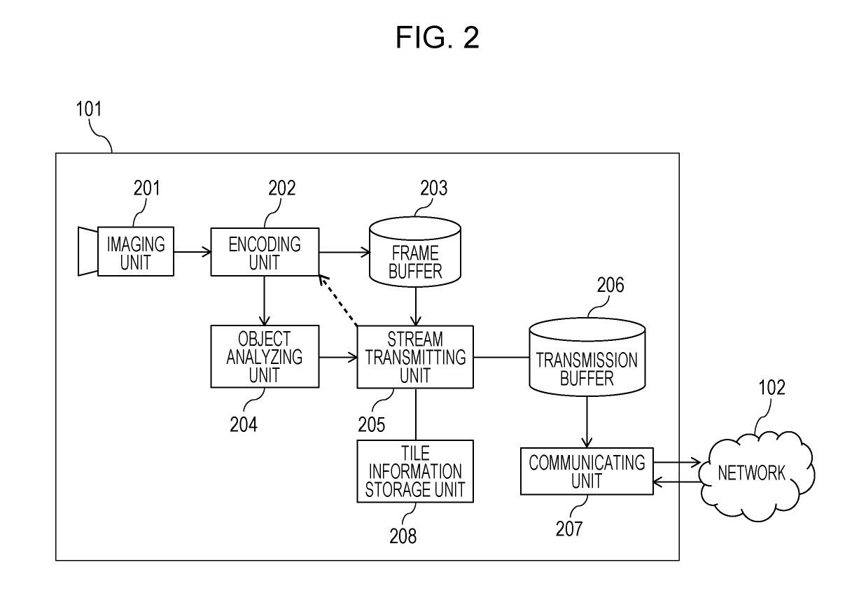

FIG. 2 is a block diagram illustrating a functional arrangement of the network camera 101 being a transmitting device of this exemplary embodiment. An image capturing unit 201 captures a moving image to generate bitmap data and outputs the generated bitmap data to an encoding unit 202. The encoding unit 202 encodes the bitmap data output from the image capturing unit 201 in encode blocks by using HEVC and outputs the encoded data as encoded frame data to a frame buffer 203. The frame buffer 203 stores the encoded frame data output from the encoding unit 202. An object analyzing unit 204 analyzes (or recognizes) an object within the moving image based on bitmap data and a motion vector output when it is encoded by the encoding unit 202 and determines priority levels of tiles based on a location of the object for each frame.

A stream transmitting unit 205 converts the encoded frame data stores in the frame buffer 203 to an RTP/TCP packet and outputs it to a transmission buffer 206. The stream transmitting unit 205 selectively transmits encoded tile data of each tile (data corresponding to each tile) (hereinafter, called selective tile transmission process) based on an available storage capacity of the transmission buffer 206 and the priority levels of the tiles. Details will be described below. The stream transmitting unit 205 is capable of instructing the encoding unit 202 to perform re-encoding by using intra-frame prediction on a designated tile and encoding by using intra-frame prediction on the designated tile in the next frame. The stream transmitting unit 205 outputs tile priority level states and a transmission state of encoded tile data to a tile information storage unit 208 in order to temporarily store them as tile information. The term “encoded tile data” in this exemplary embodiment refers to data acquired by dividing encoded frame data into tiles.

The transmission buffer 206 includes a queue (hereinafter, called a packet queue) for storing a packet for each destination client (receiving device). A communication unit 207 monitors the transmission buffer 206 and, if a transmission packet is stored therein, transmits the transmission packet to corresponding destination of the clients 103 to 105 over the network 102. The communication unit 207 transmits a next packet in the destination packet queue in response to an ACK packet transmitted from the destination one of the clients 103 to 105 based on the TCP specification.

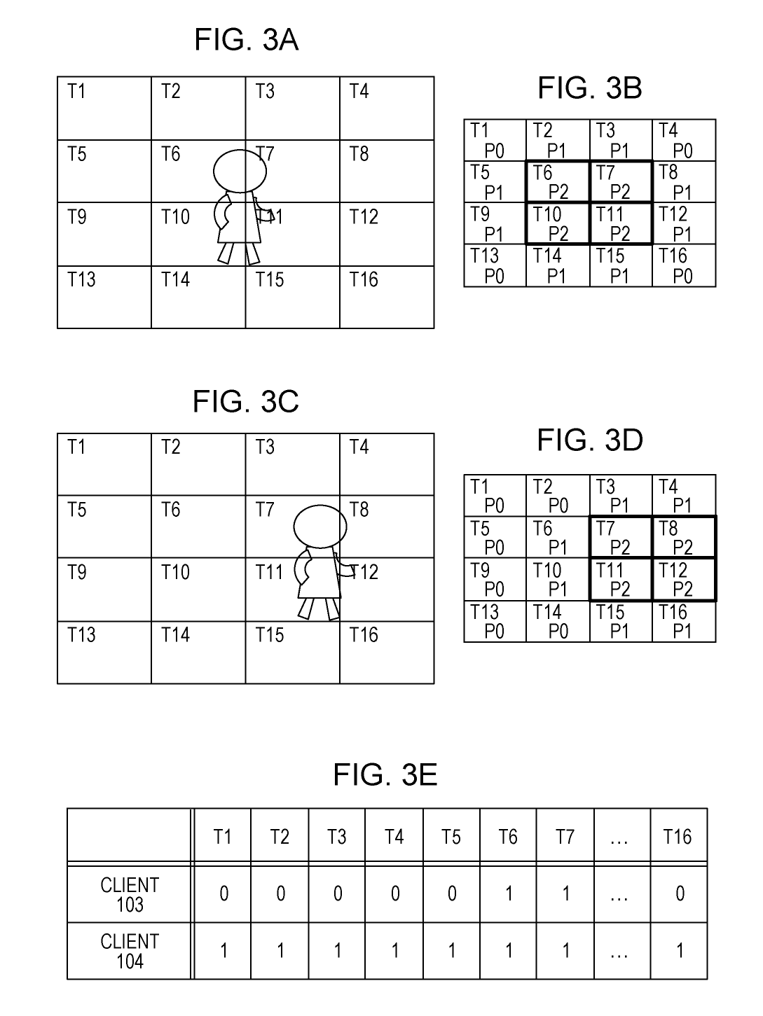

Next, FIGS. 3A to 3E will be described. FIGS. 3A and 3C are schematic diagrams regarding tile divisions in one frame of bitmap data. According to this exemplary embodiment, one frame of bitmap data is vertically and horizontally divided into four and is divided into a total of 16 tiles. For example, T1 to T16 in FIG. 3A refer to indicators of tiles. FIGS. 3A and 3C illustrates a state recognized as that a human figure is shown partially in the tiles T6, T7, T10, and T11 based on an object analysis by the object analyzing unit 204.

FIG. 3B and FIG. 3D illustrate priority levels assigned to the tiles by the object analyzing unit 204 in one frame of bitmap data. For example, FIG. 3B illustrates that priority levels P0 to P2 are assigned to tiles based on a result of an object analysis performed by the object analyzing unit 204 as illustrated in FIG. 3A. Referring to FIG. 3B, a high priority level P2 is assigned to the tiles T6, T7, T10, and T11 recognized as having a human figure therein in FIG. 3A. While a high priority level P2 is assigned to a tile recognized as having a human figure in FIG. 3A and FIG. 3C according to this exemplary, the present invention is not limited thereto. In other words, the high priority level P2 may be assigned to a tile recognized as having an object based on a result of an object analysis. The high priority level P2 may be assigned to a tile recognized as having a human figure or goods and a surrounding tile (such as a time adjacent to the recognized tile) of the recognized tile. The high priority level P2 may be assigned to a tile at a preset location. Priority levels of tiles may be instructed and determined by the clients 103 to 105.

FIG. 3E illustrates an example of a table for managing transmission information describing whether encoded tile data of tiles have been transmitted to clients (receiving devices) or not. The table in FIG. 3E illustrates whether encoded tile data of tiles have been transmitted to clients or not. Referring to the table in FIG. 3E, if encoded tile data has been transmitted, 1 is recorded, and if not, 0 is recorded. In FIG. 3E, a tile (1) whose encoded tile data has been transmitted is called a transmission tile, and a tile (0) whose encoded tile data has not been transmitted is called non-transmission tile. In other words, referring to FIG. 3E, the encoded tile data of the tiles T6 and T7 have been transmitted to the client 103, and the encoded tile data of all tiles have been transmitted to the client 104.

Such information on priority levels of tiles illustrated in FIGS. 3B and 3D and transmission states of encoded tile data of tiles illustrated in FIG. 3E are output from the stream transmitting unit 205 to a tile information storage unit 208, and the tile information storage unit 208 stores and manages them.

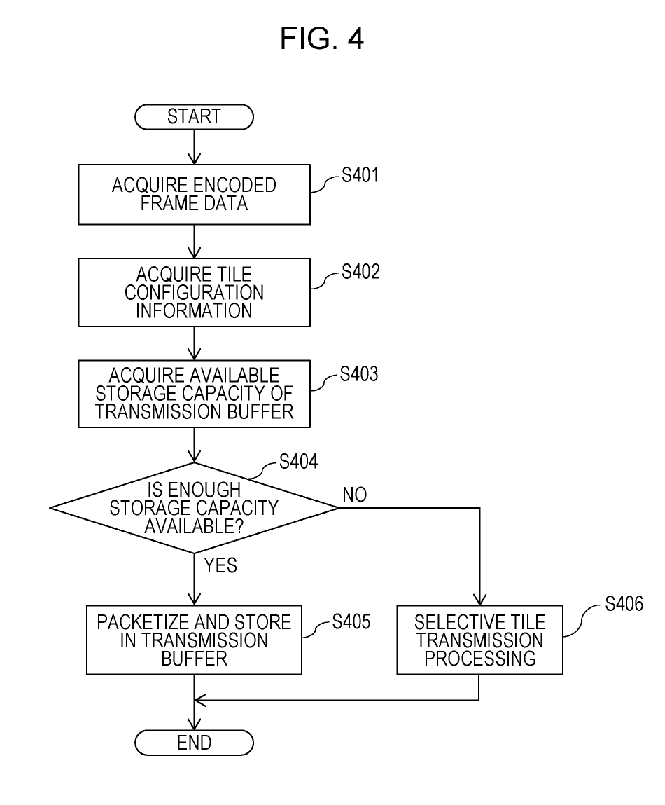

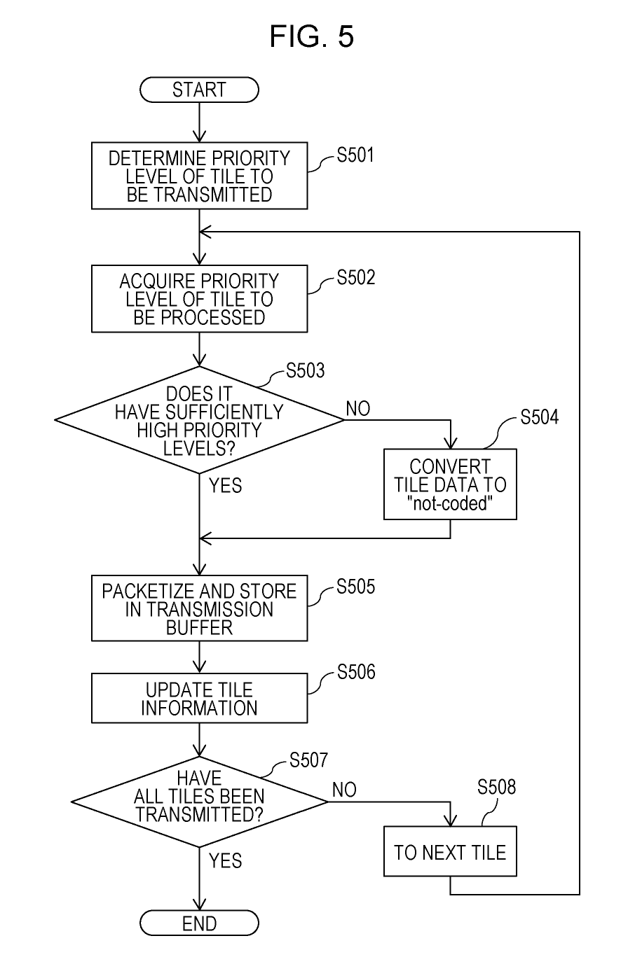

Next, steps of the selective tile transmission process to be performed by the stream transmitting unit 205 will be described with reference to FIGS. 4 and 5.

First, steps will be described with reference to FIG. 4. In step S401, the stream transmitting unit 205 acquires encoded frame data output by the encoding unit 202 from the frame buffer 203. Next, in step S402, the stream transmitting unit 205 analyzes the encoded frame data and thus acquires tile configuration information including information describing the number of tiles within a frame, the coordinates of the tiles and data sizes (amounts of data) of the tiles. According to this exemplary embodiment, the tile configuration information includes information describing the number of tiles within a frame the coordinates of the tiles and/or data sizes (amounts of data) of the tiles. However, the present invention is not limited thereto. In other words, the tile configuration information may only be required to include information describing at least data sizes of tiles and may include information on the number of tiles or other information instead of the number of tiles within a frame the coordinates of the tiles.

Next, in step S403, the stream transmitting unit 205 acquires information regarding a data size of an available storage capacity of the transmission buffer 206 (hereinafter, called an available storage capacity). The stream transmitting unit 205 then compares the data size of the entire encoded frame data acquired from the frame buffer 203 and the available storage capacity of the transmission buffer 206 and thus determines whether the encoded frame data may be stored in the transmission buffer 206 or not (step S404). If it is determined in step S404 that the transmission buffer 206 has an enough available storage capacity (YES in step S404), the stream transmitting unit 205 packetizes and stores the encoded frame data to the transmission buffer 206 (step S405). After step S405, the stream transmitting unit 205 ends the transmission process of the encoded frame data. On the other hand, if it is determined in step S404 that the transmission buffer 206 does not have an enough available storage capacity (NO in step S404), the stream transmitting unit 205 performs a selective tile transmission process (step S406). In step S404, the stream transmitting unit 205 first determines whether the transmission buffer 206 has an enough available storage capacity or not to determine whether the data may be stored in the transmission buffer 206 or not. However, for example, whether the available storage capacity of the transmission buffer 206 is equal to or lower than a predetermined capacity or not may be determined instead. Apparently, the stream transmitting unit 205 may determine whether the available storage capacity of the transmission buffer 206 is lower than a predetermined capacity or not.

Next, a more detail procedure of step S406 will be described with reference to FIG. 5. First, based on the data sizes of tiles acquired in step S402 and the available storage capacity of the transmission buffer 206 acquired in step S403, the stream transmitting unit 205 determines the priority level of a tile to be transmitted (step S501). Referring to FIG. 3A and FIG. 3B, it is assumed for example, that the priority level of the tile to be transmitted is determined as the priority level P2 in this exemplary embodiment. Next, the stream transmitting unit 205 acquires priority levels assigned to tiles in order from the first tile (T1) (step S502). The stream transmitting unit 205 determines whether the priority levels of tiles acquired in step S502 correspond to the priority level of the tile to be transmitted which is determined in step S501 or not, that is, whether the priority levels are P2 or not in this exemplary embodiment (step S503). While the stream transmitting unit 205 determines whether the priority levels of tiles acquired in step S502 are P2 or not in step S503 of this exemplary embodiment, the present invention is not limited thereto. In other words, according to the present invention, a plurality of priority levels of a tile to be transmitted may be set and the stream transmitting unit 205 may determine that the priority levels of tiles acquired in step S502 correspond to the priority level of the tile to be transmitted if they are any one of predetermined priority levels of the set plurality of priority levels.

In step S503, if it is determined the priority levels assigned to the tiles correspond to the priority level of the tile to be transmitted (YES in step S503), the stream transmitting unit 205 moves to step S505. The stream transmitting unit 205 packetizes and stores data of the tile (hereinafter, called tile data) in the transmission buffer 206 in step S505 and moves to step S506. In step S506, the stream transmitting unit 205 records that the encoded tile data of the tile has been transmitted from the transmitting device to the tile information storage unit 208 and updates the tile information.

On the other hand, if it is determined in step S503 that the priority levels assigned to the tiles are not the priority level of the tile to be transmitted (NO in step S503), the stream transmitting unit 205 moves to step S504. The stream transmitting unit 205 in step S504 clears (resets and deletes) an encoded tile data portion of the tile data of the tile to be transmitted. The stream transmitting unit 205 stores, in a header part of the tile data, tile data having a “not-coded” flag indicating that the encoded data of the tile data is empty (or the tile is not encoded). Next, the stream transmitting unit 205 packetizes the tile data generated in step S504 and stores the packetized tile data to the transmission buffer 206 in step S505 and moves to step S506. In step S506, the stream transmitting unit 205 records that the encoded tile data of the tile have been transmitted from the transmitting device to the tile information storage unit 208 and updates the tile information. Here, if it is determined in step S503 that the assigned priority level is not the priority level of the tile to be transmitted (NO in step S503), the tile whose encoded data part is cleared and for which the “not-coded” flag is set is recorded as a non-transmission tile (0) in step S504.

After the update of the tile information in step S506, the stream transmitting unit 205 determines whether the target frame contains any unprocessed tile or not (step S507). If the target frame contains no unprocessed tile (YES in step S507), the stream transmitting unit 205 ends the transmission process of the encoded frame data. On the other hand, if the target frame contains an unprocessed tile (NO in step S507), the stream transmitting unit 205 selects the next tile (step S508) and repeats steps from acquisition of the priority level of the tile selected in step S508 (from step S502).

By performing the steps illustrated in FIGS. 4 and 5, the tiles T6, T7, T10, and T11 in the example in FIG. 3B are stored in the transmission buffer 206 with the tile data directly output from the encoding unit 202. All of the other tiles are converted to tile data without encoded data and having the “not-coded” flag set by the step S504 and are stored in the transmission buffer 206.

While the “not-coded” flag is used in this exemplary embodiment, the present invention is not limited thereto. In other words, information may be used which describes that the encoded tile data have been deleted or no encoded tile data exist. Transmitting a tile with a low priority level as not having encoded data clearly informs the receiving device of the fact that the tile does not have encoded data, preventing wrong recognition of the decoded location of a tile transmitted directly as encoded tile data.

The transmitting device 101 (stream transmitting unit 205) according to this exemplary embodiment performs a selective transmission process of a tile based on the available storage capacity of the transmission buffer 206 and the priority level of the tile. However, the present invention is not limited thereto. In other words, a transmitting device of the present invention may only be required to perform a selective tile transmission process based on the possible data size and transmission rate for transmission and reception. Such a selective tile transmission process may be performed based on information describing whether decoding processing in a receiving device has a high load or not. A transmitting device of the present invention may perform such a selective tile transmission process based on information describing whether any delay is occurring in an AKC packet reply process based on TCP in a receiving device.

The stream transmitting unit 205 of this exemplary embodiment may control a transmission process in tiles based on the available storage capacity of the transmission buffer 206 and the priority level of the tiles by performing the steps illustrated in FIGS. 4 and 5, as described above. In other words, tile data encoded by the encoding unit 202 is transmitted for a tile having a high priority level, and tile data of a tile with a low priority level is transmitted without encoded tile data by deleting encoded tile data of the tile and setting the flag “non-coded”. This may reduce the size of tile data of a tile having a low priority level and thus significantly reduce its proportion in the transmission buffer 206.

Because the conventional frame transmission skip and GOP transmission skip may also skip a tile with a high priority level in frames and in GOPs, a break due to the skipped tile with a high priority level may occur in the moving image. However, the selective tile transmission process of this exemplary embodiment allows transmission of the moving image corresponding to the tile with a high priority level as successive frames because transmission control may be performed in tiles based on the available storage capacity of the transmission buffer 206. Therefore, this exemplary embodiment may prevent a break in a moving image reproduced in frames and GOPs in a reception side. In other words, this exemplary embodiment may provide a smoother moving image of a tile part having a high priority level without breaks, compared with conventional methods.

Use of the “not-coded” flag indicating that a tile having a low priority level does not have encoded tile data allows transmission of a reduced size of tile data of a tile having a low priority level still based on an encoded data format. A receiving device having received the tile data containing the “not-coded” flag is allowed to acquire information describing that the encoded tile data of the tile does not exist so that decoded locations of the tiles may be correctly acquired.

### Second Exemplary Embodiment

According to the first exemplary embodiment, there has been described the transmission control process in a transmitting device in a case where the available storage capacity of a transmission buffer within the transmitting device is equal to or lower than a predetermined capacity. Next, according to a second exemplary embodiment, there will be described a transmission control process in a transmitting device for transmitting a tile transmitted as a non-transmission tile according to the first exemplary embodiment as a transmission tile if the priority level of the tile transmitted as a non-transmission tile reaches the priority level of a tile to be transmitted after a lapse of a time period. For example, a process which will be described below according to this exemplary embodiment is performed in a case where it is judged that there is a possibility for improvement of the transmission rate of encoded data after the transmission control process in a transmitting device controls so as to temporarily reduce the transmission rate of encoded data according to the first exemplary embodiment. Here, the case where it is judged that there is a possibility for improvement of the transmission rate of encoded data may refer to, for example, a case where congestion in a network is alleviated or a load of an encoding process on a moving image in a transmission side so that the available storage capacity of the transmission buffer may be increased.

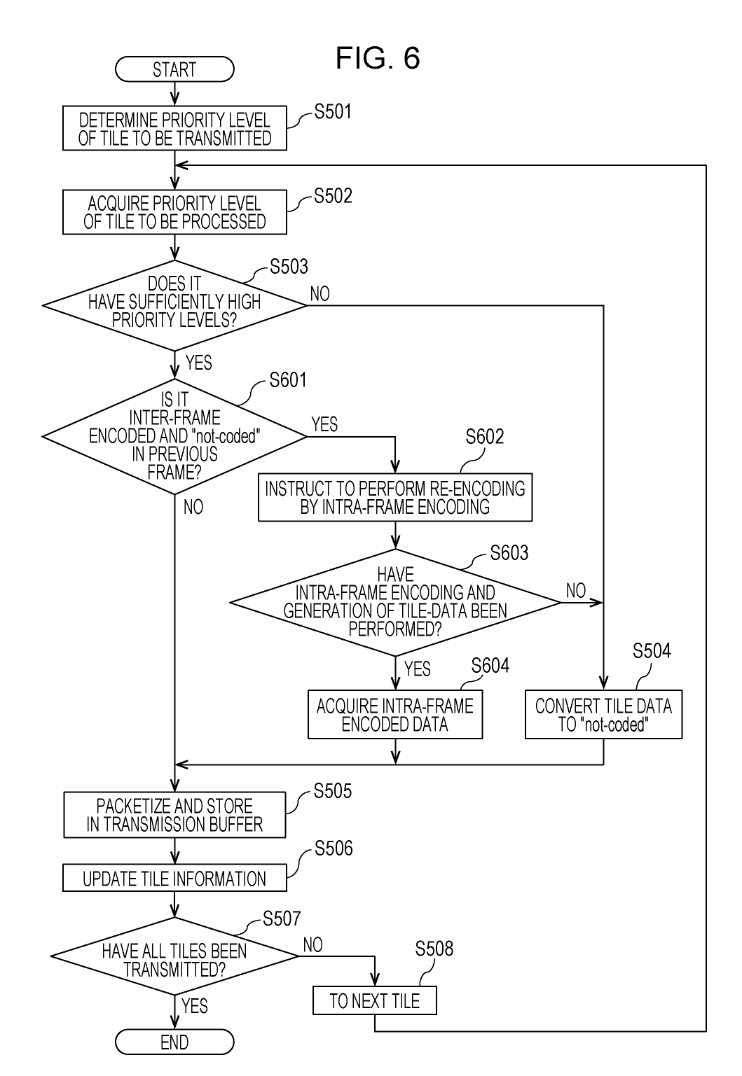

According to this exemplary embodiment, a tile to be changed to a transmission tile is selected from tiles handled as non-transmission tiles with low priority levels based on the priority levels of the tiles. If the selected tile corresponds to inter-frame-encoded moving image data, the moving image of the tile is re-encoded by intra-frame encoding and is then transmitted. The inter-frame encoding is encoding by using inter-frame prediction, and the intra-frame encoding is encoding by using intra-frame prediction. And, this exemplary embodiment is different from the first exemplary embodiment in the detail steps of the selective tile transmission process (step S406) in FIG. 4. Thus, for simplicity, steps in FIG. 6 which are detail steps of step S406 in this exemplary embodiment will only be described, and the repetition of the same description will be omitted here.

FIG. 6 illustrates a process for reconstructing encoded data of a non-transmission tile according to this exemplary embodiment in addition to the flowchart in FIG. 5 according to the first exemplary embodiment.

The stream transmitting unit 205 performs the processing in steps S501 to S503 similarly to the first exemplary embodiment. If it is determined in step S503 according to this exemplary embodiment that a target tile has a priority level of a tile to be transmitted (YES in step S503), the stream transmitting unit 205 determines whether the tile is to be re-encoded by using intra-frame prediction or not (step S601). More specifically, in step S601, whether the target tile is a tile encoded by using inter-frame prediction and the target tile has been transmitted as tile data of a non-transmission tile in a previous frame to the target frame or not is determined.

If it is determined in step S601 that the target tile is a tile encoded by using intra-frame prediction (NO in step S601), encoded tile data of the target tile is stored in the frame buffer 203. In other words, because re-encoding is not necessary therefor, the stream transmitting unit 205 moves to step S505. If the target tile is set as a transmission tile in the previous frame (NO in step S601), the target tile is successive encoded data that may be decoded irrespective of use of intra-frame prediction or inter-frame prediction for the encoding. Thus, the stream transmitting unit 205 determines that re-encoding of the target tile is not necessary and moves to step S505. Because the same processing as that of first exemplary embodiment is performed in and after step S505, the description will be omitted.

On the other hand, there will be described processing to be performed if the target tile is a tile encoded by using inter-frame prediction and the target tile has been transmitted as tile data of a non-transmission tile in a previous frame to the target frame (YES in step S601). In this case, the stream transmitting unit 205 instructs the encoding unit 202 to re-encode the target tile by using intra-frame prediction (step S602).

A concrete example thereof will be described with reference to FIGS. 3A to 3E. FIG. 3C is a schematic diagram of tile divisions in one frame after the frame in FIG. 3A. In the example in FIG. 3C, the object analyzing unit 204 recognizes that a human figure is shown in a part covering tiles T7, T8, T11, and T12. FIG. 3D illustrates that priority levels P0 to P2 are assigned to the tiles based on the object analysis result by the object analyzing unit 204 as illustrated in FIG. 3C. Referring to FIG. 3D, the high priority level P2 is assigned to the tiles T7, T8, T11, and T12 where a human figure is recognized as in FIG. 3C. Thus, when the priority levels of the tiles change as illustrated in FIGS. 3B to 3D, the priority level of the tiles T8 and T12 changes from the priority level P1 as in FIG. 3B to the priority level P2 as in FIG. 3D.

Therefore, in step S601, the stream transmitting unit 205 determines that the tiles T8 and T12 in FIG. 3D are tiles to be re-encoded (YES in step S601). In step S602, the stream transmitting unit 205 instructs the encoding unit 202 to encode the tiles T8 and T12 by using intra-frame prediction. On the other hand, the tiles excluding the tiles T8 and T12 are determined in step S601 as tiles not to be re-encoded (NO in step S601). Then, in step S505, the stream transmitting unit 205 packetizes the encoded frame data of the tiles and stores them to the transmission buffer 206, similarly to the first exemplary embodiment.

Next, processing in step S602 and subsequent steps will be described. In step S602, the stream transmitting unit 205 instructs the encoding unit 202 to re-encode the tile by using intra-frame prediction and moves to step S603.

In step S603, the stream transmitting unit 205 determines whether the encoded tile data re-encoded by the encoding unit 202 has been stored in the frame buffer 203 within a predetermined time period from the instruction of the re-encoding in step S602 or not. This is performed because there are a case where the encoding unit 202 performs re-encoding and outputs the data to the frame buffer 203 immediately after the instruction of the re-encoding in step S602 and a case where the encoding unit 202 outputs the re-encoded data to the frame buffer 203 with a delay of appropriately several frames. Either case may occur depending on the processing power and procedure of the encoding unit 202.

If it is determined in step S603 that the encoded tile data of the target tile has been stored in the frame buffer 203 (YES in step S603), the stream transmitting unit 205 acquires the encoded tile data from the frame buffer 203 (step S604). The stream transmitting unit 205 packetizes the acquired encoded tile data and stores them to the transmission buffer 206 (step S505). On the other hand, if it is determined in step S603 that the encoded tile data of the target tile has not been stored in the frame buffer 203 (NO in step S603), the stream transmitting unit 205 moves to step S504. This is because the encoding unit 202 needs to process the target tile as a non-transmission tile until its encoded data is generated and is stored in the frame buffer 203. Thus, if it is not re-encoded within a predetermined time period (NO in step S603), the target tile is processed as a non-transmission tile so that the entire target frame may be processed without lowering the real-time characteristic.

As described above, the stream transmitting unit 205 of this exemplary embodiment may control the transmission process in tiles by performing the steps illustrated in FIG. 4 and FIG. 6 based on the available storage capacity of the transmission buffer 206 and the priority levels set for tiles.

When changes of priority levels assigned to tiles changes the tile for which encoded tile data is to be transmitted, control may be performed so as to transmit the encoded tile data of the tile to be transmitted. In other words, when changes of priority levels assigned to tiles change the tile for which encoded tile data is to be transmitted, re-encoding by using intra-frame prediction is performed thereon. Thus, the frame with the changed priority level even in the middle of a GOP may be decoded by a receiving device, and the corresponding moving image may be reproduced.

The encoding unit 202 may have a processing load increased by the re-encoding, but the data size to be handled is smaller than the data size to be handled by re-encoding in frames. The re-encoding in tiles easily allows performing parallel processes without reference to other tiles in prediction and encoding processes. Thus, re-encoding in tiles may reduce the amount of increase of the processing load more than re-encoding in the whole frame.

Therefore, the technology according to this exemplary embodiment may be implemented and be effective in a use case where a stream of a moving image is transmitted simultaneously to a plurality of receiving devices having different communication states. For example, the technology of this exemplary embodiment may be implemented for a surveillance camera which does not have many simultaneous encoding functions but needs to transmit a stream of a moving image simultaneously to a plurality of receiving devices having different communication states.

### Third Exemplary Embodiment

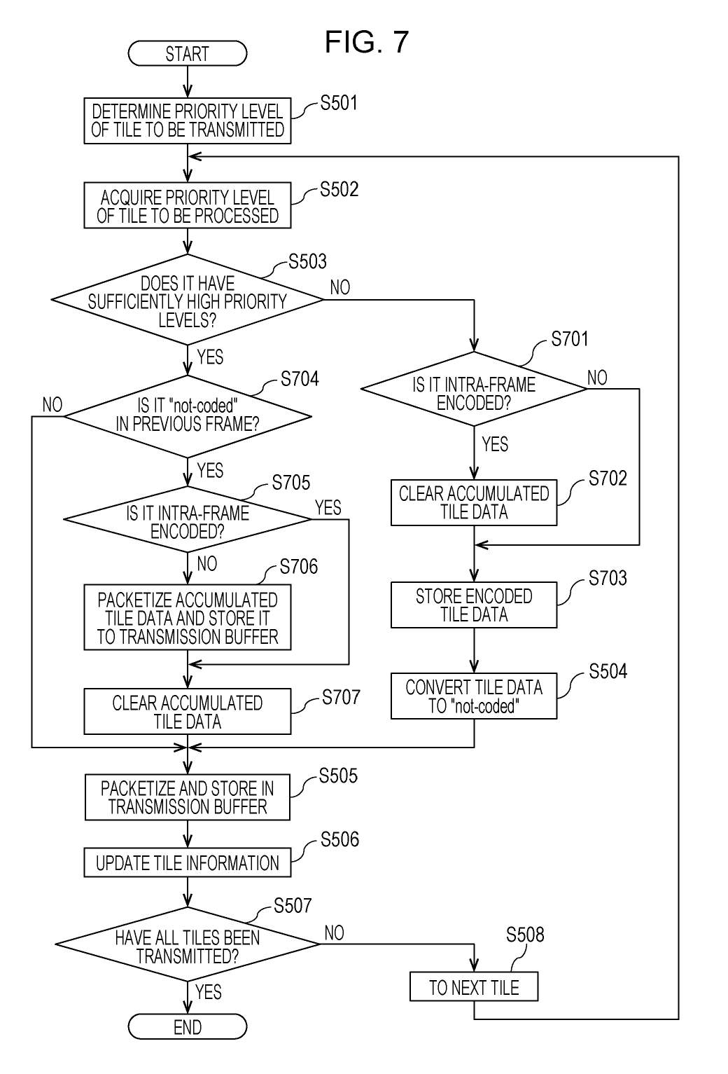

A third exemplary embodiment relates to a transmission control process in a case where it is judged that an increase of a transmission rate may be allowed, like the second exemplary embodiment, after transmission control is performed by temporarily reducing a transmission rate for transmitting encoded data by a transmitting device, like the first exemplary embodiment. According to the second exemplary embodiment, if the stream transmitting unit 205 determines that a target tile needs re-encoding, the stream transmitting unit 205 instructs the encoding unit 202 to perform re-encoding processing on the target tile so that the encoded data of the target tile may be transmitted. According to this exemplary embodiment, whole prestored encoded tile data are transmitted so that encoded tile data of the target tile may be transmitted even it is in middle of a GOP. Though encoded tile data are prestored in the frame buffer 203 according to this exemplary embodiment, the present invention is not limited thereto. In other words, such encoded tile data may be stored in other buffer than the frame buffer 203 within the network camera 101 or may be stored in an external storage device. Because this exemplary embodiment is different from the first exemplary embodiment in detail processing of the selective tile transmission process (step S406) in FIG. 4, the detail processing in step S406 according to this exemplary embodiment will be described with reference to FIG. 7 for simplicity, and the repetition of the same description will be omitted here.

FIG. 7 illustrates reconstruction processing to be performed on encoded data of a non-transmission tile according to the third exemplary embodiment in addition to the flowchart in FIG. 5 according to the first exemplary embodiment. The stream transmitting unit 205 performs processing in steps S501 to S503 similarly to the first exemplary embodiment.

If it is determined that a target tile does not have a priority level of a tile to be transmitted in step S503 of this exemplary embodiment (NO in step S503), the stream transmitting unit 205 moves to step S701. In step S701, the stream transmitting unit 205 checks whether the encoded tile data of the tile has been encoded by using intra-frame prediction.

First, if it is determined in step S701 that the encoded tile data has not been encoded by using intra-frame prediction (NO in step S701), the stream transmitting unit 205 stores the encoded tile data to the frame buffer 203 (step S703). The stream transmitting unit 205 stores the encoded tile data in the frame buffer 203 such that which tile the encoded tile data belong to may be identifiable. After the processing in step S703, the same processing is performed as that of the first exemplary embodiment. That is, the stream transmitting unit 205 clears an encoded tile data portion of tile data of the tile (step S504) and packetizes the converted tile data and stores it to the transmission buffer 206 (step S505).

On the other hand, in step S701, if it is determined that the encoded tile data has been encoded by using intra-frame prediction (YES in step S701), the stream transmitting unit 205 moves to step S702. Next, the stream transmitting unit 205 deletes the encoded tile data of the tile already stored in the frame buffer 203 (step S702) and stores the encoded tile data having been encoded by using intra-frame prediction to the frame buffer 203 (step S703). After the processing in step S703, the stream transmitting unit 205 performs processing in steps S504 and S505, as described above. The stream transmitting unit 205 in step S702 deletes encoded tile data of the stored tile for the following reason. That is, it is because a target frame encoded by using intra-frame prediction does not need immediate decoding processing of tile data in the previous frame to the target frame. Because the process which resumes the storage from tile data encoded by using intra-frame prediction, the upper limit of the number of encoded time data is equal to the number of frames of a GOP length.

Next, there will be described the case where it is determined in step S503 that target tile has the priority level of the tile to be transmitted (YES in step S503). If YES is determined in step S503, the stream transmitting unit 205 determines whether the tile in the previous frame to the target frame has been transmitted as non-transmission tile data or not (step S704).

First, if it is determined in step S704 that the tile has been transmitted as a non-transmission tile in the previous frame to the target frame (YES in step S704), the stream transmitting unit 205 moves to step S705. In step S705, the stream transmitting unit 205 determines whether the encoded tile data of the tile is data encoded by using intra-frame prediction or not. If it is determined in step S705 that the encoded tile data is not data encoded by using intra-frame prediction (NO in step S705), the stream transmitting unit 205 moves to step S706. In step S706, the stream transmitting unit 205 retrieves the encoded tile data of the tile already stored in the frame buffer 203, packetizes the encoded tile data and stores it to the transmission buffer 206. Next, the stream transmitting unit 205 deletes the encoded tile data stored in the frame buffer 203 (step S707). After this, similarly to the first exemplary embodiment, the stream transmitting unit 206 packetizes the encoded tile data and stores the packetized encoded tile data to the transmission buffer 206 (step S505). If it is determined in step S705 that the encoded tile data is data encoded by using intra-frame prediction (YES in step S705), the stream transmitting unit 205 moves to the step S707. For that, the stream transmitting unit 205 does not transmit encoded tile data stored in the frame buffer 203. After this, similarly to the first exemplary embodiment, the stream transmitting unit 206 packetizes the encoded tile data and stores the packetized encoded tile data to the transmission buffer 206 (step S505).

On the other hand, if it is determined in step S704 that the tile has not been transmitted as a non-transmission tile (NO in step S704), it means that the tile is a transmission tile in the previous frame to the target frame. In other words, the encoded data of the tile are continuously transmitted in the previous frame to the target frame and in the target frame. Therefore, if NO is judged in step S704, the stream transmitting unit 205 then packetizes the encoded tile data and stores it to the transmission buffer 206, similarly to the first exemplary embodiment (step S505).

Next, a concrete example will be described with reference to FIGS. 3A to 3E. The change of the moving picture (frame) from FIG. 3A to FIG. 3C involves changes of the priority levels of the tiles from FIG. 3B to FIG. 3D, as in the second exemplary embodiment. The changes of the priority levels of the tiles from FIG. 3B to FIG. 3D include a change of the priority level of the tile T8 and tile T12 to the priority level (P2) of the transmission target. The stream transmitting unit 205 then performs the processing in step S705 and step S706 on the tile T8 and tile T12 having its priority level changed to the priority level of the transmission target. In other words, as a result of the changes of the frame from FIG. 3A to FIG. 3C, the stream transmitting unit 205 transmits all of stored encoded tile data up to the previous frame illustrated in FIG. 3A to the target frame with respect to the tile T8 and tile T12. After that, the stream transmitting unit 205 controls so as to transmit the encoded tile data of the tile T8 and tile T12 in FIG. 3C.

As described above, the stream transmitting unit 205 of this exemplary embodiment may control the transmission processes in tiles based on the available storage capacity of the transmission buffer 206 and the priority levels set to the tiles by performing the procedures illustrated in FIG. 4 and FIG. 7.

The stream transmitting unit 205 of this exemplary embodiment may further control transmission of encoded tile data of a tile to be transmitted even in a case where changes of priority levels assigned to tiles may change the tile to be transmitted having encoded tile data. In other words, in a case where a tile that has been a non-transmission tile is changed to a tile to be transmitted because of changes of the priority levels assigned to the tiles, the re-encoding is performed by using intra-frame prediction. Thus, even a frame having such a changed priority level is in middle of a GOP, the moving image data may be decoded by a receiving device so that the moving image may be reproduced.

Successive tile data which are transmitted as a set (called a set transmission) may be decoded at a different time from the decoding time for the current frame. However, because data encoded in tiles are decoded in tiles, such data may be decoded independent from the decoding time of the whole frame by a decoder in the reception side. Even a plurality of communication loads increased by the set transmission may be sufficiently small because the data size of the encoded tile data of the whole frame is small.

### Fourth Exemplary Embodiment

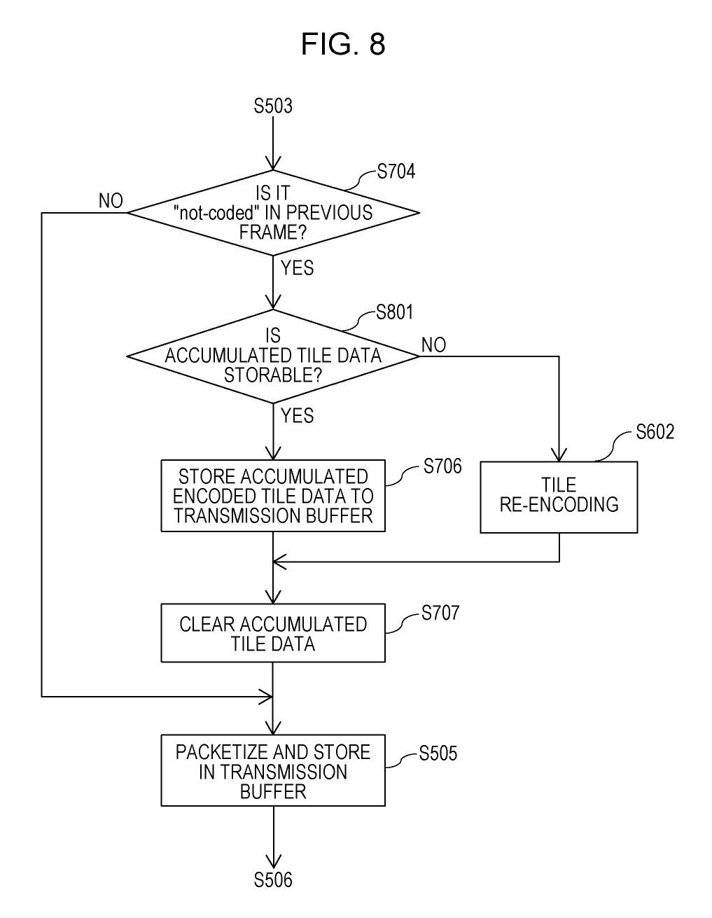

According to a fourth exemplary embodiment, one of the control methods for resuming a transmission of encoded tile data according to the second exemplary embodiment and third exemplary embodiment is selected when a transmission resuming process is executed as in FIG. 8. FIG. 8 is a flowchart illustrating processing (step S602) for re-encoding a target tile by using intra-frame prediction similarly to the processing according to the second exemplary embodiment in addition to the series of steps from step S704 to step S504 in FIG. 7 according to the third exemplary embodiment.

If it is determined in step S704 in FIG. 8 that the tile has been transmitted as a non-transmission tile in the previous frame to the target frame (YES in step S704), the stream transmitting unit 205 moves to step S801. In step S801, the stream transmitting unit 205 checks whether the stored encoded tile data may be transmitted by the method of the third exemplary embodiment or not. In other words, in step S801, the stream transmitting unit 205 determines whether the encoded tile data stored in the frame buffer 203 is to be transmitted or the encoded tile data generated by re-encoding is to be transmitted. In step S801, the stream transmitting unit 205 judges whether the data size of the encoded tile data stored in the frame buffer 203 is small enough for the available storage capacity of the transmission buffer 206 or not, similarly to the method according to the third exemplary embodiment. Next, if the transmission buffer 206 has an enough storage capacity available for storing the data (YES in step S801), the stream transmitting unit 205 stores the stored encoded tile data to the transmission buffer 206 in (step S706), similarly to the third exemplary embodiment. The stream transmitting unit 205 further deletes the encoded tile data from the frame buffer 203 (step S707). On the other hand, if it is determined that the transmission buffer 206 does not have an enough storage capacity for the data (NO in step S801), the stream transmitting unit 205 performs the re-encoding processing according to the second exemplary embodiment (step S602) and moves to step S707. In step S707, the frame transmitting unit 205 deletes the encoded tile data stored in the frame buffer 203.

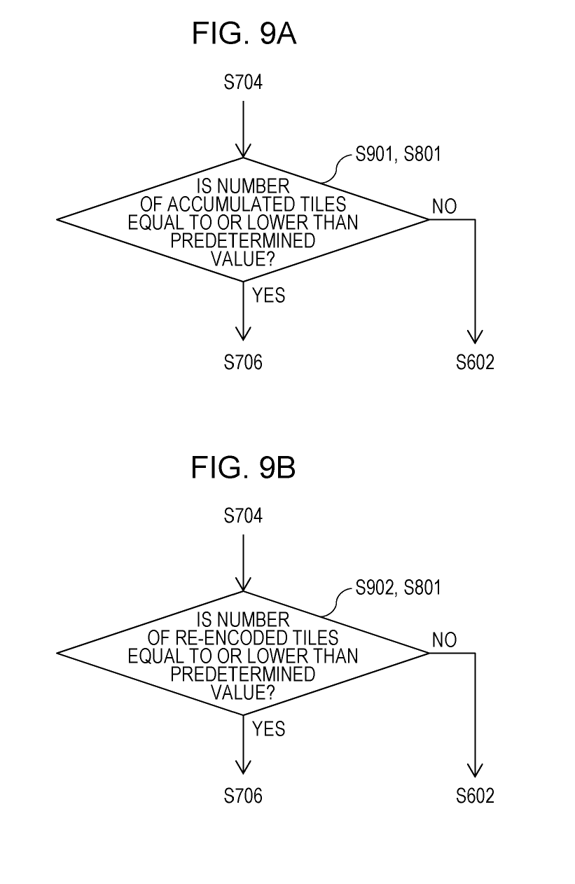

In the flowchart in FIG. 8, the stream transmitting unit performs the determination based on the data size of the encoded tile data stored in the frame buffer 203 and the available storage capacity of the transmission buffer 206. FIGS. 9A and 9B illustrate another example.

Step S901 in FIG. 9A corresponds to the determination process (step S801) for determining which is to be performed between the process for transmitting the stored encoded tile data and the process for re-encoding the encoded tile data in FIG. 8. The stream transmitting unit 205 in step S901 in FIG. 9A judges whether the number of tiles in the stored encoded tile data is equal to or lower than a predetermined threshold value (set value) or not. If so in step S901 (YES in step S901), the stream transmitting unit 205 moves to the process for transmitting the encoded tile data stored in the frame buffer 203 (step S706). If not in step S901 (NO in step S901) on the other hand, the stream transmitting unit 205 moves to the re-encoding processing (step S602). According to the method illustrated in FIG. 9A, the stream transmitting unit 205 performs the transmission or re-encoding processing on encoded tile data stored in the frame buffer 203 based on the number of tiles of the encoded tile data, as described above. This method allows control of a transmitting device so as to transmit the stored encoded tile data in a case where the turn for reproduction of the frame (access image) to resume the transmission of encoded tile data in a GOP including the access image is closer to the turn of the key frame at the beginning of the GOP. In other words, because the access image is close to the key frame at the beginning of the GOP and the number of tiles of the encoded tile data stored in the frame buffer 203 is low, a lower number of tiles of the encoded tile data may be transmitted. This may alleviate increases of a transmission processing load and a communication load in a transmitting device and a decoding processing load in a receiving device, for example. On the other hand, in a case where the turn for reproduction of the access image in a GOP including the access image is farther from the turn of the key frame at the beginning of the GOP, the number of tiles of the encoded tile data to be transmitted increases. This may increase a transmission processing load and a communication load in a transmitting device and a decoding processing load in a receiving device, for example.

Step S902 in FIG. 9B corresponds to the determination process (step S801) for determining which is to be performed between the process for transmitting the stored encoded tile data and the process for re-encoding the encoded tile data in FIG. 8. In step S902 in FIG. 9B, the stream transmitting unit 205 judges whether the number of tiles to be re-encoded is equal to or lower than a predetermined threshold value (set value) or not. If so in step S902 (YES in step S902), the stream transmitting unit 205 moves to re-encoding processing (step S602). If not in step S902 (NO in step S902) on the other hand, the stream transmitting unit 205 moves to processing for transmitting the encoded tile data stored in the frame buffer 203 (step S706). According to the method illustrated in FIG. 9B, the stream transmitting unit 205 performs the transmission or re-encoding processing on the encoded tile data based on the number of tiles to be re-encoded. According to this method, if the number of tiles to be re-encoded is higher than the predetermined value, the encoded tile data stored in the frame buffer 203 is transmitted without performing the re-encoding, which may alleviate an increase of a load involved in encoding processing in transmitting device.

The processing in FIG. 9A and FIG. 9B allows a transmitting device according to this exemplary embodiment to select one of the two methods for resuming transmission of encoded tile data according to the second exemplary embodiment and third exemplary embodiment based on the available storage capacity of the transmission buffer 206 and the status of a given communication bandwidth.

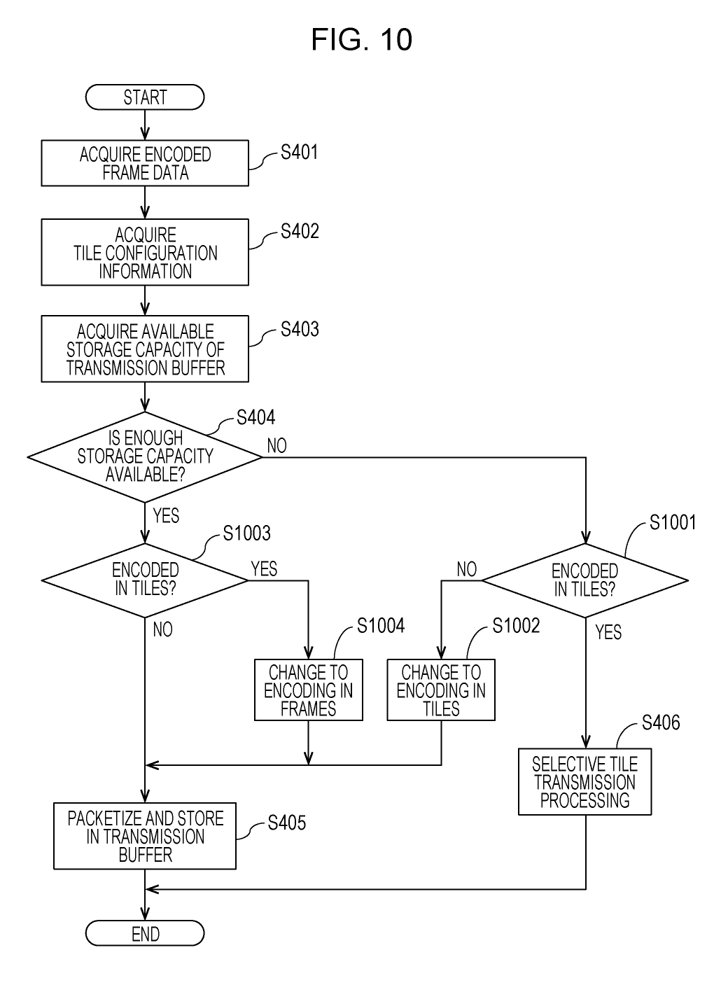

Next, with reference to FIG. 10, there will be described a procedure for selecting whether a moving image frame is to be encoded in tiles or in frames based on the available storage capacity of the transmission buffer 206 before the encoding is performed. FIG. 10 is a flowchart illustrating a part of the processing according to this exemplary embodiment in addition to steps of the selective tile transmission processing based on the available storage capacity of the transmission buffer 206 and the priority levels set to tiles as in FIG. 4 according to the first exemplary embodiment. Referring to FIG. 10, the determination on whether the transmission buffer 206 has an enough available storage capacity or not (or whether the encoded tile data of the target tile may be stored in the transmission buffer 206 or not) (the same processing as that of step S404 in FIG. 4) is further followed by the processing below.

If it is judged in step S404 in FIG. 10 that the transmission buffer 206 does not have an enough available storage capacity (NO in step S404), the stream transmitting unit 205 judges whether the target frame has been encoded in tiles or not (step S1001). If not in step S1001 (NO in step S1001), the stream transmitting unit 205 changes the encoding to the encoding in tiles to be performed on the target frame (step S1002) and moves to step S405. In step S405, the stream transmitting unit 205 packetizes the encoded frame data generated by encoding and stores it to the transmission buffer 206.

If it is judged in step S404 on the other hand that the transmission buffer 206 has an enough storage capacity available (YES in step S404), the stream transmitting unit 205 judges whether the target frame has been encoded in tiles or not (step S1003). If so in step S1003 (YES in step S1003), the stream transmitting unit 205 changes the encoding to the encoding in frames to be performed on the target frame (step S1004) and moves to step S405. In step S405, the stream transmitting unit 205 packetizes the encoded frame data generated by encoding and stores it to the transmission buffer 206.

By performing the procedure as described above, the encoding may be changed to encoding in frames or encoding in tiles based on the available storage capacity of the transmission buffer 206 in addition to the control over selective transmission of encoded tile data according to the first exemplary embodiment.

The processing for resuming transmission of encoded tile data may be executed separately in tiles as in the processing flows illustrated in FIGS. 6 to 8 according to the exemplary embodiment. Thus, even when the data transmissions of encoded tile data of a plurality of tiles occur simultaneously, the methods in FIG. 9A and FIG. 9B may be combined to apply the proper resuming schemes to individual tiles to undergo the transmission resuming process. For example, in a case where an object within a moving image moves in a passage of time as illustrated in FIGS. 3A to 3D, the locations and number of tiles to be changed from non-transmission tiles to transmission tiles because of an increase of their transmission priorities may differ at different times. In this case, the stream transmitting unit 205 of this exemplary embodiment is allowed to perform the following. That is, the stream transmitting unit 205 is allowed to select at the correct times re-encoded data or stored encoded data for transmission based on the number of tiles that may be re-encoded by using intra-frame prediction and the size of the stored encoded data of tiles.

### Fifth Exemplary Embodiment

According to the first to fourth exemplary embodiments, the processing units illustrated in FIG. 2 are configured by hardware. However, any of processes to be performed by the processing units illustrated in FIG. 2 may be executed by a computer program.

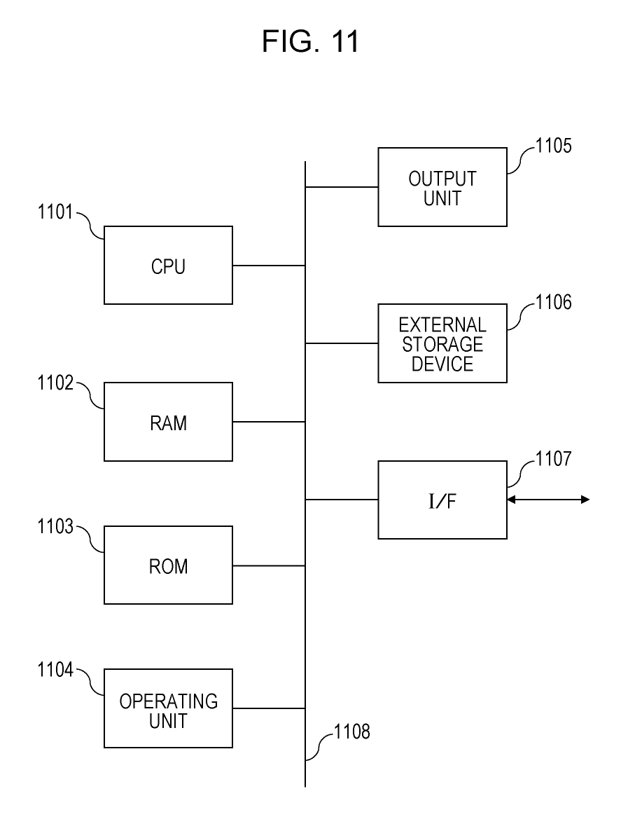

FIG. 11 is a block diagram illustrating a hardware configuration example of a computer usable for executing processes to be performed by processing unit in an image transmission apparatus according to the first to fourth exemplary embodiments.

A CPU 1101 uses a computer program and data stored in a RAM 1102 and a ROM 1103 to generally control the computer and execute the aforementioned processes as operations of the image encoding apparatus according to the aforementioned exemplary embodiments. In other words, the CPU 1101 functions as the processing units in FIGS. 1, 3, and 6.

The RAM 1102 has an area for temporarily storing a computer program and data loaded from an external storage device 1106 and data externally acquired through an I/F (interface) 1107. The RAM 1102 has a work area usable by the CPU 1101 for executing the processes. In other words, the RAM 1102 may be assigned as a frame memory or may provide other areas for proper purposes, for example.

The ROM 1103 may store setting data and a boot program for the computer, for example.

The operating unit 1104 includes a keyboard and a mouse, for example, and may be operated by a user of the computer to input an instruction to the CPU 1101.

An output unit 1105 presents a result of processing performed by the CPU 1101. The output unit 1105 may be configured by a liquid crystal display, for example.

The external storage device 1106 may be a large-capacity information storage device such as a hard disk drive. The external storage device 1106 may store a computer program for causing the CPU 1101 to implement an operating system (OS) and the functions of the components illustrated in FIGS. 1, 3, and 6. The external storage device 1106 may further store images to be processed.

A computer program and data stored in the external storage device 1106 may be loaded to the RAM 1102 properly under control of the CPU 1101 and may be processed by the CPU 1101.

A network such as a LAN and the Internet and other apparatuses such as a projector and a display device may be connected to the I/F 1107, the computer may acquire and transmit various information through the I/F 1107.

A bus 1108 may connect the components above.

Operations in the configuration above may be operations described with reference to the flowcharts to be performed mainly under control of the CPU 1101.

### Other Exemplary Embodiments

HEVC is used above as a moving image encoding scheme for encoding moving image data according to the aforementioned exemplary embodiments. However, the present invention is not limited thereto. In other words, the moving image encoding scheme is not limited to HEVC but may be any scheme which allows processing in tiles or blocks generated by dividing a frame. The communication protocol to be used is not limited to TCP, but various transmission protocols may be used. In other words, the process for converting encoded tile data based on the communication state according to the present invention is applicable to an example in which RTP/UDP and RTCP are used to monitor a communication bandwidth.

While recognition of an object in a moving image is performed to determine priority levels of tiles according to the aforementioned exemplary embodiments, the present invention is not limited thereto. In other words, the present invention is applicable also to a case where priority levels of tiles are determined in response to an instruction from a reception side.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-233494, filed Nov. 11, 2013, which is hereby incorporated by reference herein in its entirety.

What is claimed is:

1. An image transmission apparatus which transmits encoded data acquired by encoding an image, the apparatus comprising:
a first acquiring unit configured to acquire information on a congestion of transmission of the encoded data;
a second acquiring unit configured to acquire a priority level of a target tile that is one of tiles acquired by dividing the image; and
a determination unit configured to determine encoded data corresponding to the target tile to be output externally from the image transmission apparatus based on the information on the congestion of transmission acquired by the first acquiring unit and the priority level of the target tile acquired by the second acquiring unit.

2. The image transmission apparatus according to claim 1, further comprising a transmission buffer configured to store encoded data to be transmitted, wherein
the first acquiring unit acquires information on an available storage capacity of a transmission buffer as the information regarding a congestion of transmission; and
the determination unit determines encoded data corresponding to the target tile to be output externally from the image transmission apparatus based on the available storage capacity of the transmission buffer acquired by the first acquiring unit and the priority level of the target tile acquired by the second acquiring unit.

3. The image transmission apparatus according to claim 1, further comprising:
a transmission buffer configured to store encoded data to be transmitted; and
a judgment unit configured to judge whether an available storage capacity of the transmission buffer is lower than a predetermined value or not in a case where the first acquiring unit acquires information on the available storage capacity of the transmission buffer as the information on a congestion of transmission, wherein
the determination unit controls so as to output encoded data of a tile selected within the image externally from the image transmission apparatus if the judgment unit judges that the available storage capacity of the transmission buffer acquired by the first acquiring unit is lower than the predetermined value.

4. The image transmission apparatus according to claim 1, wherein the priority level of the tile acquired by the second acquiring unit is based on a result of object analysis performed on the image.

5. The image transmission apparatus according to claim 1, further comprising an encoding unit configured to encode the image, wherein
tiles acquired by dividing the image are areas that may be processed independently from each other by the encoding unit.

6. The image transmission apparatus according to claim 1, further comprising a transmitting unit configured to transmit the encoded data.

7. The image transmission apparatus according to claim 6, further comprising:
a transmission buffer configured to store encoded data to be transmitted; and
a third acquiring unit configured to acquire information on a priority level of a tile to be transmitted included in the transmission image based on a data size of a transmission image to be transmitted and an available storage capacity of the transmission buffer, wherein
the determination unit determines to transmit data excluding encoded data of the target tile which is encoded by the encoding unit in a case where the priority level of the target tile acquired by the second acquiring unit is lower than the priority level of the tile to be transmitted acquired by the third acquiring unit.

8. The image transmission apparatus according to claim 7, wherein the determination unit determines to transmit information describing that there is no encoded data of the target tile which is encoded by the encoding unit by using the transmitting unit in a case where the priority level of the target tile acquired by the second acquiring unit is lower than the priority level of the tile to be transmitted acquired by the third acquiring unit.

9. The image transmission apparatus according to claim 7, wherein the determination unit determines to transmit encoded data of the target tile which is encoded by the encoding unit by using the transmitting unit in a case where the priority level of the target tile acquired by the second acquiring unit is higher than the priority level of the tile to be transmitted acquired by the third acquiring unit.

10. The image transmission apparatus according to claim 6, further comprising:
a transmission buffer configured to store encoded data to be transmitted; and
an encoding unit configured to encode by using intra-frame prediction a tile that has not been transmitted by the transmitting unit in a case where the transmission buffer changes its state from a state inhibiting the encoded tile to be stored to a state allowing it to be stored.

11. The image transmission apparatus according to claim 10, further comprising a storage unit configured to store encoded data of the encoded tile, wherein
the determination unit determines whether encoded data acquired by encoding a tile that has not been transmitted by the transmitting unit is to be transmitted or encoded data stored in the storage unit in a case where the transmission buffer changes its state from a state inhibiting the encoded tile to be stored to a state allowing it to be stored and determines encoded data to be transmitted by the transmitting unit based on a result of the determination.

12. The image transmission apparatus according to claim 11, wherein the determination unit determines whether encoded data acquired by encoding a tile that has not been transmitted by the transmitting unit is to be transmitted or encoded data stored in the storage unit based on the number of tiles of encoded data stored in the storage unit in a case where the transmission buffer changes its state from a state inhibiting the encoded tile to be stored to a state allowing it to be stored and determines encoded data to be transmitted by the transmitting unit based on a result of the determination.

13. The image transmission apparatus according to claim 11, wherein the determination unit determines whether encoded data acquired by encoding a tile that has not been transmitted by the transmitting unit is to be transmitted or encoded data stored in the storage unit based on the number of tiles that have not been transmitted in a case where the transmission buffer changes its state from a state inhibiting the encoded tile to be stored to a state allowing it to be stored and determines encoded data to be transmitted by the transmitting unit based on a result of the determination.

14. A method for controlling an image transmission apparatus which transmits encoded data acquired by encoding an image, the method comprising:
acquiring information on a congestion of transmission of the encoded data;
acquiring a priority level of a target tile that is one of tiles acquired by dividing the image; and
determining encoded data corresponding to the target tile to be output externally from the image transmission apparatus based on the information on the congestion of transmission acquired by the first acquiring unit and the priority level of the target tile acquired by the second acquiring unit.

15. A non-transitory computer-readable storage medium storing a program for causing a computer to execute coding the program comprising:
computer-executable instructions that transmit encoded data acquired by encoding an image;
computer-executable instructions that acquire information on a congestion of transmission of the encoded data;
computer-executable instructions that acquire a priority level of a target tile that is one of tiles acquired by dividing the image; and
computer-executable instructions that determine encoded data corresponding to the target tile to be output externally from the image transmission apparatus based on the information on the congestion of transmission acquired by the first acquiring unit and the priority level of the target tile acquired by the second acquiring unit.
